(19) United States
(12) Patent Application Publication
(10) Pub. No.: US 2007/0244762 A1
(43) Pub. Date: Oct. 18, 2007

(54) Default Final Offers in Online Auctions

(76) Inventors: Anthony Gert Du Preez, Malvern East (AU); Jason Scott Ellenport, East Brighton (AU)

Correspondence Address: FENWICK & WEST LLP, SILICON VALLEY CENTER, 801 CALIFORNIA STREET, MOUNTAIN VIEW, CA, 94041, US

(21) Appl. No.: 10/586,980

(22) PCT Filed: Jan. 28, 2005
(86) PCT No.: PCT/AU05/00097

§ 371 Date: May 18, 2007

(30) Foreign Application Priority Data
Jan. 29, 2004 (AU) 2004900418

(51) Int. Cl. G06Q 30/00

(52) U.S. Cl. 705/26

(57) ABSTRACT

The present invention relates generally to a system and method for conducting online auctions, and has particular application in conducting business over a network of computers such as the Internet for establishing materials or service supply contracts. The invention relates to use of default final offers in an online auction event between a first party and at least two counter-parties, being competing participants in the online auction event, and the method includes the steps of designating a time period for the online auction event, permitting each of said competing participants to prescribe a default final offer before or during the online auction event, conducting the auction between the competing participants by permitting the participants to submit bids, checking, at or after the expiry of said time period, default final offers prescribed by competing participants, and, if a competing participant's default final offer represents a competitive offer, registering the offer as a valid bid without any further intervention by that competing participant. The invention, which can be applied to both forward and reverse auctions, permits competing participants to selectively safeguard their respective positions in the event of inadvertent disconnection from the online auction system, or other circumstances that prevent them actively participating in a critical period of the auction event.

### FIELD OF THE INVENTION

The present invention relates generally to a system and method for conducting online auctions. It has particular application in conducting business over a network of computers such as the Internet, for establishing materials or service supply contracts. In particular, the invention relates to use of default final offers in an online bidding event.

### BACKGROUND

In applicant's published application WO-02/21347, a ‘factored bidding’ online materials supply contract system is described. The system, involving a computer network including at least one buyer computer, an administrator computer and at least two supplier computers, makes it possible for a buyer to establish an underlying base supply contract with multiple approved suppliers, to prepare a ‘Request for Quotation’ (RFQ) and issue this as a Purchasing Requirement (PR), such as a ‘Bill of Materials’ (BOM) to those approved suppliers, and then to conduct an online bidding event over the computer network between panel members who choose to validate the PR. In this bidding process, ratings are applied automomatically to offers received from respective suppliers, in order to factor relevant supplier parameters into the tender process. When applied in a so-called ‘reverse auction’ process, the invention therefore affords dynamic comparison of offers as suppliers bid downwardly against one another to achieve the best result (lowest factored bid) for the buyer. The system and method described above has been tested extensively and shown to provide significant advantages over other approaches to conducting online auctions.

The system includes means to provide to each bidder (supplier) a ‘target bid’, also referred to as a ‘current bid to win’ (CBTW), in respect of the supply contract, the target bid calculated by the administrator computer to dynamically indicate to a supplier the offer that that supplier must submit to compete with the best previous offer, once the respective ratings have been applied to the various offers put forward.

In an alternative form, the invention involves an analogous ‘factored pricing’ process, allowing the buyer to apply factoring before issuing an RFQ to the prospective suppliers, or to allow a supplier to adjust specification criteria to effect ‘self factoring’ of an offer.

Under the rules of the method referred to above, an online bidding event is run for a fixed period of time (such as thirty minutes). At the end of this time, as measured by the server clock, the lowest factored bid is accepted and all the participants notified whether they have been successful or not. As published application WO-02/21347 describes in further detail, there are certain situations in which bid submission may be affected by the participants' ability to respond, which can be exacerbated by any delays in the communication links between the computers engaged in the event. To ameliorate this problem, the system includes the possibility of time extension periods, triggered by a bid submission in a prescribed closing period of the auction event. This extension function may be limited to certain of the competing bidders (such as those with the lowest factored bids), and may be realised by presenting the bidders with an opportunity to present a ‘best and final bid’ (BAF), at or below that party's target bid.

In U.S. Pat. No. 6,499,018 assigned to Freemarkets Inc, the concept of setting limits on participant bids is discussed, in order to allow, for example, the auction coordinator to assign to each bidder in a reverse auction an individual bid ceiling, or to provide an ability to detect, prevent and remove erroneous bids during the auction process, particularly when individual cost component bids are involved within an overall auction event.

A problem that has been identified with operation of real-time online auction events such as those referred to above is the risk that a supplier computer can become disconnected from the computer network, and hence from the administrator computer, in the final stages of the auction event, before they are able to place their best offer. Such unforeseen circumstances can give rise to potential disparities in the bidding process between legitimate competing bidders, possibly compromising the overall transparency and integrity of the auction methodology.

Any discussion of documents, acts, materials, devices, articles and the like is included in this specification solely for the purpose of providing a context for the present invention. It is not suggested or represented that any of these matters formed part of the prior art base or were common general knowledge in the field relevant to the present invention as it existed in Australia or elsewhere before the priority date of any claim of this application.

### SUMMARY OF THE INVENTION

It is an object of the present invention to at least partly address the inconveniences of the prior art, and to this end there is provided a method of conducting an online auction event between a first party and at least two counterparties, being competing participants in the online auction event, the method including the steps of:

designating a time period for the online auction event;

permitting each of said competing participants to prescribe a default final offer before or during the online auction event;

conducting the auction between the competing participants by permitting the participants to submit bids;

checking, at or after the expiry of said time period, default final offers prescribed by competing participants; and

if a competing participant's default final offer represents a competitive offer, registering the offer as a valid bid without any further intervention by that competing participant.

Preferably, if a default final bid offer is registered as a valid bid, the online auction event is extended into an extension period to allow other competing participants to submit counterbids.

The step of a registering a competing participant's default final offer as a valid bid preferably involves checking that default final offer to bids submitted during the online auction event and to other default final offers.

In a reverse auction event, the first party is a buyer and the counterparties are competing suppliers, and a competitive offer represents a lower price to said buyer. In this case, the default final offer represents a supplier's floor price for the event.

In a forward auction event, the first party is a seller and the counterparties are competing buyers, and a competitive offer represents a higher price to said seller. In this case, the default final offer represents a buyer's ceiling price for the event.

Preferably the method includes maintaining confidential a default final offer entered by a competing participant unless and until that offer is registered as a valid bid.

In a preferred form, the method includes, for a competing participant which has entered a default final offer, the steps of:

comparing all offers submitted by that competing participant during the online auction event with that default final offer; and

providing a warning message to that competing participant if the result of the comparison indicates that an erroneous offer has been submitted.

Preferably, the online auction is carried out over a computer network comprising an auction administrator computer (which may be operated by the first party) and at least two counterparty computers, operated by said competing participants, and default final offers prescribed by competing participants by entering into respective counterparty computers are stored on said administrator computer. In order to maintain the confidentiality of a default final offer prescribed by a competing participant, a stored default final offer is not made available to a user of said administrator computer unless and until that offer is registered as a valid bid.

The invention therefore affords each competing participant an opportunity to enter and store their own confidential ‘reserve’ potential bid, which will be automatically submitted, and thus become a registered bid in the auction, if it is found to be a competitive offer at the end of the designated auction event period. Crucially, this permits a competing participant to selectively safeguard their position in the event of inadvertent disconnection from the online auction system, or other circumstances that prevent them actively participating in a critical period of the auction event. In addition, the default final offer can be used to check bids made by a particular competing participant during the event, and the participant warned if they have submitted a bid that is lower (in the case of a reverse auction) or higher (in the case of a forward auction) than the default final offer, to guard against bids possibly entered in error.

The designated time period for the online auction event may include an event extension period, if the rules of the auction process allow for event extensions in prescribed circumstances (such as a reserve price negotiation period, or in the event a valid bid is entered shortly before the end of an initially designated period).

The use of a registered default final bid triggering an extension period ensures that the credibility and transparency of the auction process is conserved, allowing competing participants to submit counterbids.

In a preferred embodiment, the online auction involves the award of a supply contract to a supplier selected from a panel of predetermined suppliers which each has a base supply contract with a first party buyer, and the computer network over which the online auction is carried comprises at least one buyer computer, an administrator computer, and at least two supplier computers, said buyer being the first party and said predetermined suppliers being the competing participants, the method including the steps of:

establishing key parameters for the supply contract to be submitted by the administrator computer to the at least two supplier computers (eg. price, quality, delivery and service);

establishing a rating for each supplier of the panel of predetermined suppliers related to said key parameters;

receiving during the auction supplier offers from the supplier computers; and

applying the respective ratings to each supplier offer to adjust that offer prior to comparison with any other offer.

The rating for each supplier may be based at least partially upon past performance of that supplier for each parameter. The parameters are, for example, previous timeliness of delivery of materials, quality of delivered materials, price, etc. The step of applying a rating for each supplier may be based at least partially upon other parameters outside the control of that supplier for each parameter, such as forecast material demand, commodity price forecasts, exchange rate forecasts, industry trends, historical bidding data, etc.

Preferably, during the auction, each supplier is provided with a target bid (TB) in respect of the supply contract, the target bid calculated by said administrator computer to dynamically indicate to a supplier an offer that that particular supplier must currently submit to remain competitive in the auction. The TB for a supplier is calculated in accordance with the formula:
TBxₘ=FBₙ₋₁−(MD/SFx)
where x indicates a particular supplier X; m indicates that particular supplier's bid number; n indicates the overall bid number (ie 1^{st} bid: n=1; 2^{nd} bid: n=2;etc); FB indicates a factored bid for said particular supplier; MD indicates a set minimum bid decrement; and SF is the supplier factor set in accordance with said supplier rating.

FB may be calculated in accordance with the formula:
FBₙ=SBxₙ+(MD/SFx)−MD
where SB is a submitted bid.

Preferably, the step of checking default final offers at or after the expiry of said time period involves applying the respective ratings to the default final offers, in order to determine the default final offer which represents the most competitive offer.

The designated auction event time period for submissions of offers by said suppliers may be extendable to enable submission of an improved final offer from at least some of the supplier computers from which offer messages were received. The suppliers able to submit offers during said extension period may be selected according to prescribed criteria (such as the suppliers with the 3 or 4 lowest offers), and the method may include the step of providing the supplier with the lowest offer at the expiry of the unextended time period an option to submit the very final offer of the bidding event.

The method may include the step of, in accordance with prescribed criteria, extending the online auction event into an extension period to allow selected competing participants to submit a best and final bid, and checking default final offers entered by competing participants to assess whether they represent competitive best and final bids relative to bids submitted by the competing parties during the online auction event.

Preferably, the method includes the step of permitting each said competing participant to select whether their default final offer is to apply at the end of the auction event and/or in an extension period beyond the close of the auction event.

According to a further aspect of the invention, there is provided a computer-based system for conducting an online auction between a first party and at least two counterparties being competing participants in the online auction event, the system comprising:

a logical unit permitting designation of a time period for the online auction event;

a logical unit permitting each of said competing participants to prescribe a default final offer before or during the online auction event;

a computer application for conducting the auction between the competing participants by permitting the participants to submit bids;

a logical unit for checking, at or after the expiry of said time period, default final offers prescribed by competing participants; and

a logical unit for registering, if a competing participant's default final offer represents a competitive offer, the offer as a valid bid without any further intervention by that competing participant.

In a preferred form of this aspect of the invention, the online auction involves the award of a supply contract to a supplier selected from a panel of predetermined suppliers which each has a base supply contract with a first party buyer, and the computer network over which the online auction is carried comprising at least one buyer computer, an administrator computer, and at least two supplier computers, said buyer being the first party and said predetermined suppliers being the competing participants, the system including:

a logical unit permitting establishment of key parameters for the supply contract to be submitted by the administrator computer to the at least two supplier computers (eg. price, quality, delivery and service);

a logical unit permitting establishment of a rating for each supplier of the panel of predetermined suppliers related to said key parameters;

a logical unit for receiving during the auction supplier offers from the supplier computers; and

a logical unit for applying the respective ratings to each supplier offer to adjust that offer prior to comparison with any other offer.

As explained above, the present invention therefore affords the opportunity to overcome potential disparity in the bidding process due to unforeseen circumstances. In particular, the invention addresses the situation in which a supplier is unable to lodge a final bid due to a technical problem preventing that supplier from accessing the online system at a critical time in the auction event. This enables suppliers to mitigate the inherent technology risk associated with online bidding events. Further, participants of an auction event retain the ability to submit counterbids should a floor price be registered and accepted by the system. Given the nature of the type of auction event contemplated for application of the present invention (relatively high value, complex, short duration), the process does not aim to provide a full ‘surrogate bidding’ process of the type sometimes employed for simple ‘price-only’ online auction systems, but is limited to a ‘one-shot’ default final offer registration step triggered by the expiry of the designated time period.

In addition, the present invention provides a check against unintentionally low (in the case of reverse auctions) or otherwise erroneous supplier bids.

Further, application of the invention has a more far reaching effect on the bidding process, in that it serves to encourage suppliers to carry out more comprehensive preparation on bidding strategy and price points prior to the commencement of the auction event.

The concept of the present invention is in some ways analogous to the process of submitting sealed paper bids in conventional auction events, such bids only to be viewed by the buyer/vendor under particular circumstances. However, the method of the present invention goes significantly beyond this simple analogy.

### BRIEF DESCRIPTION OF THE DRAWINGS

A non-limiting embodiment of the invention will now be described by way of example, with reference to the accompanying drawings, in which:

FIG. 1 schematically illustrates a system for carrying out the method of the invention;

FIG. 2 is a process flow diagram showing an overview of the bidding event phases of an online auction conducted in accordance with the present invention;

FIG. 3 is a process flow diagram illustrating the steps relating to floor price extension for a participant in an online auction event in accordance with the present invention; and

FIGS. 4 and 5 represent information screens appearing to participants in the online auction.

### DETAILED DESCRIPTION OF THE INVENTION

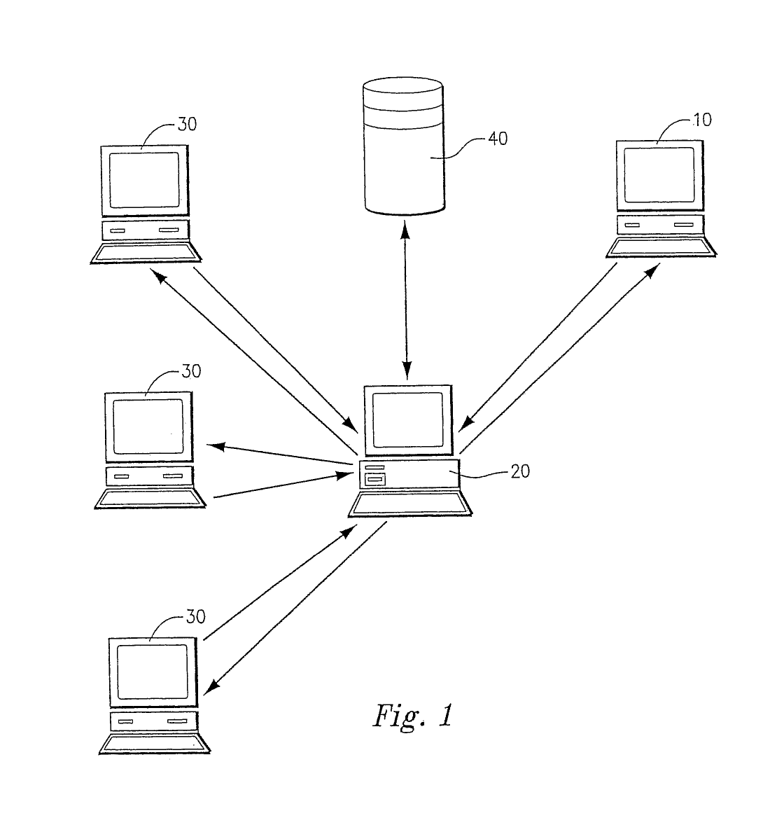

A form of the system to which the invention may be applied is described in detail in published application WO-02/21347 to the applicant, the entire content of which is included herein by reference. This system involves so-called ‘factored bidding’, which (in the context of a reverse auction) allows the buyer to set supply criteria for a particular subcategory of materials (so-called ‘reverse factored auction’, or RFA™). The system, schematically illustrated in accompanying FIG. 1, involves a computer network including at least one buyer computer 10, an administrator computer 20 and at least two supplier computers 30. These components are linked via the Internet or any other appropriate network system. It is to be noted that the system does not have to be third party controlled, as it can be initialised, updated and controlled by the procurement specialist within a buyer organisation. The buyer computer 10 and the administrator computer 20 may therefore be provided on a single computer system of the buyer organisation. A computer software application comprising the prescribed auction rules is used to manage and to run the auction event, the computer software application having a client component operating at the supplier computers 30, and a server component operating at the administrator computer 20.

The concept of factored bidding will be briefly described below.

Each material subcategory (panel) can have different supply criteria. For example Toyota might, for a category ‘Camry’ and subcategory ‘Tyres’ set supply criteria as price, quality, delivery, and service. Whereas, for Toshiba, manufacturing laptop computers, the category ‘Satellite Pro’ and subcategory ‘LCD Display’ might have supply criteria of warranty, quality and price.

Once the actual criteria are identified, the buyer numerically rates the importance of each of the identified criteria, eg from a scale of 1 to 10 (the scale itself is not important as long as the rating is representative of the importance of the criteria in an absolute and a relative sense). As a purely fictional scenario, Toyota might set: price—9, quality—7, delivery—8, and service—6, out of a maximum score of 10 for each criteria established against Camry/Tyres. The buyer then considers how well each panel supplier for the specific subcategory is performing or should be rated (from historical interactions) against each of the identified criteria.

Toyota could have 3 suppliers that can all supply Camry tyres to the required specification ie Toyota has 3 approved Camry tyre suppliers that will form the panel for the Camry Tyres subcategory in the administrator computer. Toyota then creates an overall rating for each panel member. The factor and the ratings and criteria are visible to each supplier, which allows the latter to work with the buyer to improve their assigned factor. The rating for each supplier need not be expressed as a percentage value, but may instead be simple cost penalty to be applied to any bid provided by a supplier. For example, a supplier with a relatively high factor may be allocated a $1 rating, applied as a per unit cost penalty to any bid submitted by that supplier, whereas a supplier with a lower factor may be allocated a $2 rating.

Over time administrator computer 20 collects and stores data on all the supply criteria on connected database 40. This allows the administrator computer to help buyers make decisions about how to rate a particular supplier. For example the administrator computer measures payment time, and delivery time automatically from the buyer's ERP (Enterprise Resource Planning) system. This data is analysed and presented to the supplier as an input to the supplier rating process.

In the auction event, all submitted bids are factored in accordance with an appropriate algorithm, eg by adding a minimum decrement with the respective supplier factor applied. Given that there is a minimum bid decrement (to avoid immaterial bids) and that the supplier submitted bids are factored, it is difficult for suppliers to readily calculate their next bid in order to hold the current bid. For this reason, an additional information field is provided, labelled ‘Target Bid’ (TB). This field is related directly to the supplier factor and effectively tells a supplier the maximum that they can enter as a submitted bid. Only bids at or below the target bid are designated as ‘valid bids’.

The premise of factored bidding is therefore that suppliers with higher ratings can bid higher amounts than those with lower ratings and still win the business. By factoring the minimum decrement and subtracting this from the last factored bid, the bid a supplier needs to submit to win the business can be calculated and displayed to the supplier. In this way, the auction event is run according to buyer-determined premiums or discounts, as opposed to supplier-determined ones.

During a factored bidding auction event, a ‘current lowest factored bid’ drives the bid comparison engine. This is calculated on an ongoing basis, being the lesser of the auction starting price and the amount of the factored bid which is at that point in time less than all other factored bids received and processed. The starting price is a scaled dollar (or other currency as appropriate) amount that is used at the commencement of the bidding period to establish an initial amount below which factored bids must be placed. The starting price can be specified by the controlling party (the registered buyer), or can be calculated from the registered suppliers' pre-auction bids by applying the respective bidding factors.

The ‘factored bid’ is, for each registered supplier, a scaled dollar (or other currency as appropriate) amount calculated by applying the relevant bidding factor for a registered supplier to that supplier's submitted bid. The factored bid thus takes into account the various factors that have been specified by the registered buyer for that purchasing requirement. The lowest factored bid at the close of the event is used to determine the winning bid. A factored reserve price is employed, being the reserve price adjusted in accordance with the lowest bidding factor of all the registered suppliers.

The target bid TB for a particular supplier is calculated by the administrator computer in accordance with the following formula:
TBxₘ=FBₙ₋₁−(MD/SFx) (Eq.1)
where x indicates a particular supplier X; m indicates that particular supplier's bid number; n indicates the overall bid number (ie 1^{st} bid: n=1; 2^{nd} bid: n=2;etc); FB indicates a factored bid; MD indicates a set minimum bid decrement; and SF is the supplier factor set in accordance with the supplier rating.

It should be noted that it is possible—if allowed by prescribed auction rules—for the supplier factor SFx to be changed during an auction event, at least with respect to one or more of the attributes used to calculate this value (such as, for example, delivery period, which may be selectively varied by the bidder/supplier). In other words, SFx may be a variable supplier factor, and may have a fixed component and a variable component.

FB may be calculated in accordance with the formula:
FBₙ=SBxₙ+(MD/SFx)−MD (Eq.2)
where SB is a submitted bid.

In general, an online bidding event is run for a fixed period of time (such as thirty minutes). At the end of this time, as measured by the server clock, the lowest factored bid is accepted. The use of a fixed period of time contributes to the efficient price discovery mechanism of the process, and encourages bidders (suppliers) to enter their bids within this prescribed period (which is published in advance). By limiting the entire event to a reasonably short period, bidders are encouraged to actively view and participate in the event, rather than simply to enter a bid then logoff.

In certain situations, the bid submission may be affected by the participants' physical ability to respond. This effect can mean that the buyer may not receive the very best offer possible, because the event time may expire before a counter bid can be made.

For the above reasons, it is possible to include in certain online auctions the function of an automatic extension of the event duration, if a bid is received within a specified window at the close of the event (typically five minutes). The event is then extended by, say, an additional fifteen minutes. This time extension capability is particularly useful with high value, strategic materials where significant shifts in the bidding activity can occur in the final stages of an online event. The application can include an additional parameter selected at the discretion of the controlling party to specify a maximum number of extension periods.

Additionally, a ‘Best and Final Bid’ function can be provided to afford suppliers who have submitted a bid during the course of the normal bidding event the opportunity to submit a further bid once the event has concluded, if certain determined criteria are met. It is envisaged that this functionality is reserved for the rare occasion when an otherwise winning bid must be rejected by the controlling party, for example because it is found to have failed to comply with the auction rules.

Further functionality, particularly with respect to negotiation on a reserve price set by the buyer, is described in published application WO-03/075193 to the present applicant. The entire content of this document is included herein by reference.

In accordance with the present invention, the system includes a means by which each supplier can optionally enter (at their supplier computers) a floor price (FP) during the ‘View & Validate’ phase. The floor price can then be selectively varied by the supplier at any time up until the close of the normal bidding event.

The floor price is not accessible either to the buyer or to the system administrator until submitted by the supplier, which may be done either manually or automatically through operation of the system. In this way, the floor price can be read by the system as a BAF bid by that supplier at the appropriate time.

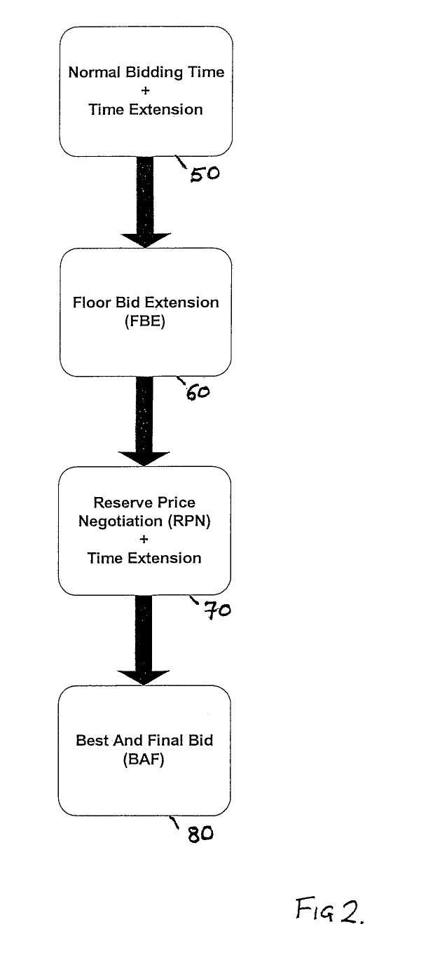

FIG. 2 illustrates the various phases of an online auction event. Before the event itself, there is a ‘View & Validate’ period, being a period in which registered competing parties are able to validate the event specification in accordance with the event rules. The subsequent phases are, as shown, the normal bidding time 50 (as prescribed for the event) plus any standard time extension periods (should bids be received within a prescribed closing period of the normal bidding time); the floor price extension period 60 (described in further detail below); the reserve price negotiation period 70 (available if the auction has not been concluded, to allow the buyer to reset the reserve price and recommence the auction event in accordance with the auction rules); and finally the ‘Best and Final Bid’ (BAF) period 80, if appropriate, in order to allow registered participants, under a prescribed set of rules, to enter a final bid at or below their target bids in situations where a winning bid has ultimately been rejected (if, for example, it is found to fail to comply with the event rules).

Floor Price Specification

In registering for an auction event, suppliers are encouraged to enter a floor price bid as protection against (a) the risk of inadvertently submitting an erroneous bid, and (b) the risk of being unable to access the online bidding event during the closing period of the event. The use of a floor price bid serves to encourage suppliers to carry out more comprehensive preparation on bidding strategy and price points prior to the commencement of the auction event.

This therefore potentially allows suppliers to participate in a bidding event without actually being online at the time of the event.

The mechanism by which the floor bid is registered on the system as a valid bid is configured to preserve the fairness and transparency of the rules of the auction process. To this end, competing suppliers are able to counterbid once a floor price of another supplier has been registered as a valid bid.

Once the system registers a supplier's floor price as a valid bid, the floor price becomes a ‘floor bid’. In other words, a ‘floor price’ may or may not be utilised, depending on its validity at the point of attempted submission, whereas a ‘floor bid’ has been registered as a valid bid according to the prescribed rules of the system.

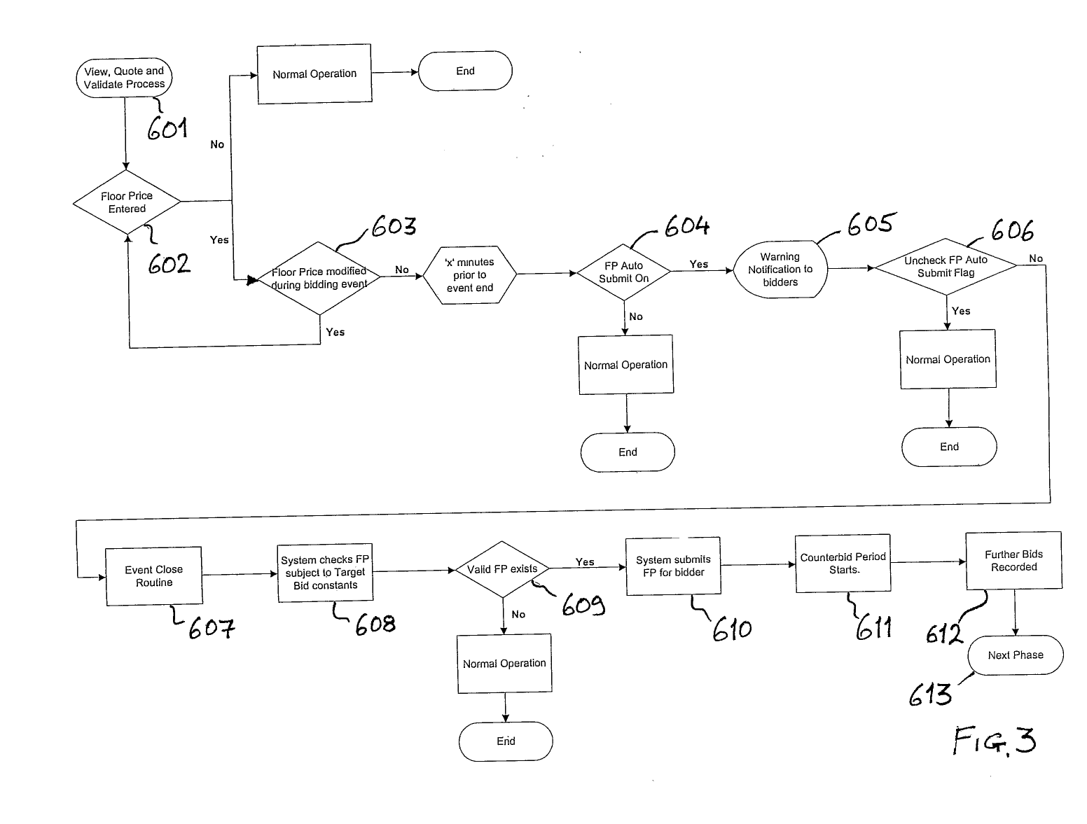

The logic flow of the relevant process steps is illustrated in FIG. 3. As this diagram shows, the floor price may be modified (or entered) by an auction participant at any time during the event (603). At a prescribed time before the close of the event the system checks which bidders have set a floor price auto submit option to “Yes” (604), and a warning notification is sent to those bidders (605) to provide an opportunity to deselect that option.

At the close of the event (607), the administrator computer 20 checks floor prices set for participant bidders, and calculates (608, 609) whether each of those prices represents a competitive bid (subject to factoring and the normal rules of the auction). The lowest of these factored floor price values is then entered as a valid bid for the corresponding participant (610), and a floor bid counterbid period is commenced (611, 612).

Once this floor bid phase is over, the process passes to the next phase (613), a reserve price negotiation period, if the buyer's reserve price has not been reached, and/or a BAF period, if required.

Preferred Functional Requirements

As indicated above, a supplier is able to enter at a floor price prior to a bidding event during the ‘View & Validate’ phase (601, 602). This option forms an additional field on the ‘Market Rules’ page, at the stage when the supplier chooses to place an initial quote. On the same page, the use of the floor price is clarified to suppliers, eg: “NOT VISIBLE TO BUYER UNTIL SUBMITTED DURING BIDDING EVENT”.

In order to remove any human intervention with the submission of the floor bid (by suppliers or by the administrator computer), the rule set for submission of the floor price is as follows:

It is not mandatory to enter a floor price onto the system.

If a floor price is registered on the system, then the system will make an attempt to submit this (610) as a valid bid at the end the last time extension period, if any, but prior to any reserve price negotiation phase. This serves the purpose of effectively allowing bidders to finish the first phase of the bidding event (indusive of time extensions).

When the time comes for floor bids to be submitted, the system runs the following checks:
Does the supplier have a floor price registered on the system to submit? If not, there is no bid to submit.
For those suppliers with a registered floor price, each supplier's bid is automatically checked against their target bid, to ensure that it meets the ‘valid bid’ criteria (608, 609).
For those suppliers whose floor price represents a valid bid, the system determines which one results in the lowest factored bid. As a result, only one bid may prevail, in which case that will be registered in the auction as the only valid bid, and the other bids will effectively be rejected. If two or more suppliers floor bids translate to an equal lowest factored bid, then the bid for the supplier with the highest overall performance rating is registered as the sole valid bid. If this evaluation still results in a ‘tie’, then the bid of the supplier who last registered a valid bid during the normal bidding or term extension period is registered as the valid bid.

For example, this might apply in a ‘price only’ event (all supplier performance factors are unity), if two or more suppliers have registered the same floor price.

An additional flag is provided to indicate whether the floor price should also be used as a default BAF bid for submission in the rare event that BAF bids need to be evaluated after close of a bidding event.

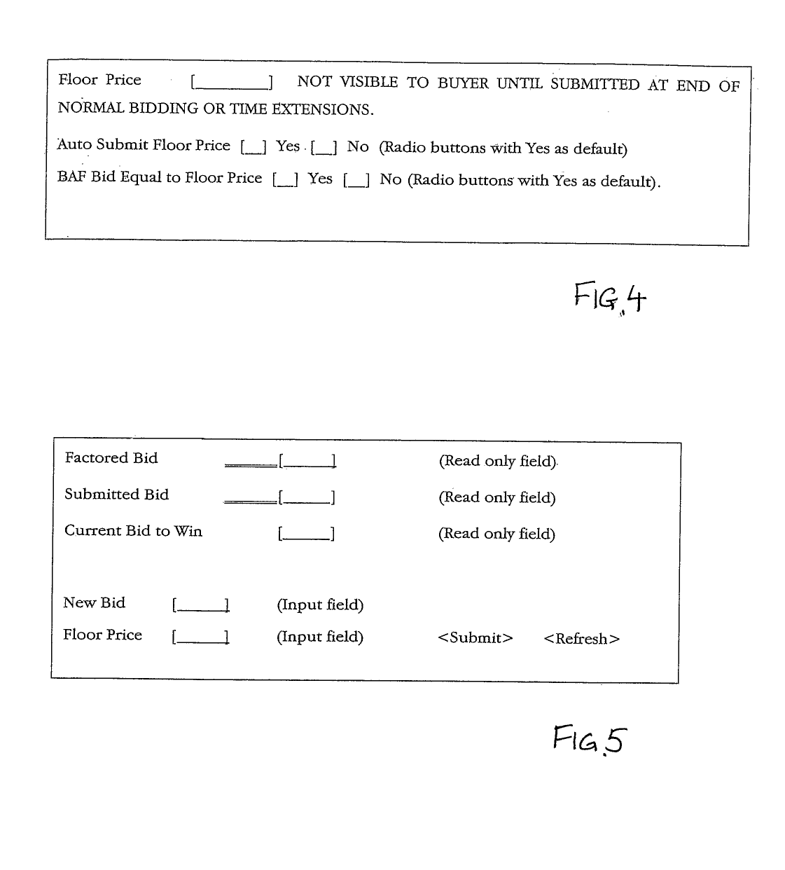

FIG. 4 shows how the market rules page appears to a supplier. The supplier has an option to set the system to auto-submit the floor price, and/or to enter the floor price as a BAF bid.

For the buyer, the market rules page includes a parameter for a ‘floor bid counterbid’ period, with similar field semantics to the time extension periods. If a valid floor bid is registered, only one floor bid counterbid period is available.

The floor price can be changed at any time by suppliers, up until the close of the normal bidding event. A “Set Floor Price” function is therefore included on the Pending page and, if necessary, on the Active page. In this case, the floor price appears as one of a series of fields on the Active page at the foot of the page. The current information on the other bid parameters appear as shown in FIG. 5. The system therefore allows a supplier to modify a floor price without necessarily submitting a new bid.

A status flag is shown on the Supplier Status screen available to the administrator or and or the buyer, indicating whether suppliers have entered a floor price, but without disclosing it.

As explained above, the logic governing the evaluation of floor prices operates in accordance with the normal bidding rules, including compliance with the suppliers' calculated target bids.

If the supplier attempts to enter a new bid that is lower than the stored floor price, then a warning dialog is displayed, requiring confirmation by the bidder that the bid is intentional, before the bid can be entered.

If a supplier cancels the auto-submit function, then they will not have a further opportunity to automatically submit their floor price. Naturally—unless inadvertently disconnected from the system—that supplier can still choose to bid at or below their originally specified floor price during the normal course of bidding or time extension periods.

At the close of bidding, when the BAF bid function is invoked, suppliers who have set the “BAF Bid Equal to Floor Price” flag to ‘Y’ will have the BAF bid field already filled in. At that point they can choose to submit this, or to override the BAF bid. It should be noted that the BAF bid is only used where events are deferred (eg because the reserve price is not reached), or where the reserve price is reached, but the buyer chooses to roll back to the next best bidder in case of supplier default.

The bid history for a floor bid stores the Bid Type as “Floor Bid”.

The invention provides an effective safeguard for participants in an auction event, whilst respecting the set rules of the system, ensuring that prices are still compared in accordance with the appropriate supplier ratings, and maintaining the audit trail on the bidding process. The invention has particular application with respect to factored bidding in reverse auction scenarios, but the same methodology can be used in any type of online auction process (eg. in a forward auction, when the prescribed value is instead employed as a bidder's ‘ceiling price’). Unlike conventional ‘sealed bid’ or ‘surrogate bid’ auctions, the floor price stage of the method of the present invention is an adjunct to the prescribed real-time auction event (commencing only when the normal auction event closes), operating in accordance with the clear and transparent auction rules. Importantly, the floor price function of the invention includes the opportunity for other bidders to counterbid against a floor price which represents a valid bid for a particular participant.

The present invention may be applied to the procurement process for any goods or services which are sufficiently valuable (to justify use of the process), specifiable (so that competing suppliers are able to interpret the requirements, and to afford a consumer basis for comparison), and contestable (ie more than one supplier has the capability to fulfil the request). Although the examples given in this description relate to ‘direct’ material, used as direct inputs to a manufacturing process, the invention is equally applicable to ‘indirect’ inputs (travel, freight, consumables, etc.) or services.

Modifications and improvements to the invention will be readily apparent to those skilled in the art. Such modifications and improvements are intended to be within the scope of this invention.

1. A method of conducting an online auction event between a first party and at least two counterparties, being competing participants in the online auction event, the method including the steps of:
designating a time period for the online auction event;
permitting each of said competing participants to prescribe a default final offer before or during the online auction event;
conducting the auction between the competing participants by permitting the participants to submit bids;
checking, at or after the expiry of said time period, default final offers prescribed by competing participants; and
if a competing participant's default final offer represents a competitive offer, registering the offer as a valid bid without any further intervention by that competing participant.

2. The method of claim 1, whereby, if a default final offer is registered as a valid bid, the online auction event is extended into an extension period to allow other competing participants to submit counterbids.

3. The method of claim 1 or claim 2, whereby the step of a registering a competing participant's default final offer as a valid bid involves comparing that default final offer to bids submitted during the online auction event and to other default final offers.

4. The method of any preceding claim, said online auction event being a reverse auction event, wherein said first party is a buyer and the counterparties are competing suppliers, and whereby a competitive offer is an offer that represents a lower price to said buyer, the default final offer representing a supplier's floor price for the event.

5. The method of any one of claims 1 to 3, said online auction event being a forward auction event, wherein said first party is a seller and the counterparties are competing buyers, and whereby a competitive offer is an offer that represents a higher price to said seller, the default final offer representing a buyer's ceiling price for the event.

6. The method of any preceding claim, including the step of maintaining confidential a default final offer entered by a competing participant unless and until that offer is registered as a valid bid.

7. The method of any preceding claim including, for a competing participant which has entered a default final offer, the steps of:
comparing all offers submitted by that competing participant during the online auction event with that default final offer; and
providing a warning message to that competing participant if the result of the comparison indicates that an erroneous offer has been submitted.

8. The method of any preceding claim whereby the online auction event is carried out over a computer network comprising an auction administrator computer, operable by or on behalf of the first party and at least two counterparty computers, operable by or on behalf of said competing participants, whereby said default final offers are prescribed by competing participants by input into respective counterparty computers and storage on said administrator computer.

9. The method of claim 8 insofar as dependent on claim 6, whereby, in order to maintain the confidentiality of a default final offer prescribed by a competing participant, a stored default final offer is not made available to a user of said administrator computer unless and until that offer is registered as a valid bid.

10. The method of any preceding claim, the online auction involving the award of a supply contract to a supplier selected from a panel of predetermined suppliers which each has a base supply contract with a first party buyer, and the computer network over which the online auction is carried comprises at least one buyer computer, an administrator computer, and at least two supplier computers, said buyer being the first party and said predetermined suppliers being the competing participants, the method including the steps of:
establishing key parameters for the supply contract to be submitted by the administrator computer to the at least two supplier computers (eg. price, quality, delivery and service);
establishing a rating for each supplier of the panel of predetermined suppliers related to said key parameters;
receiving during the auction supplier offers from the supplier computers; and
applying the respective ratings to each supplier offer to adjust that offer prior to comparison with any other offer.

11. The method of claim 10, whereby, during the auction event, each supplier is provided with a target bid (TB) in respect of the supply contract, the target bid calculated by said administrator computer to dynamically indicate to a supplier an offer that that particular supplier must currently submit to remain competitive in the auction.

12. The method of claim 10 or claim 11, whereby the step of checking default final offers at or after the expiry of said time period involves applying the respective ratings to the default final offers, in order to determine the default final offer which represents the most competitive offer.

13. The method of any preceding claim, including the step of permitting each said competing participant to select whether their default final offer is to apply at the end of the auction event and/or in an extension period beyond the close of the auction event.

14. A computer-based system for conducting an online auction between a first party and at least two counterparties being competing participants in the online auction event, the system comprising:
a logical unit permitting designation of a time period for the online auction event;
a logical unit permitting each of said competing participants to prescribe a default final offer before or during the online auction event;
a computer application for conducting the auction between the competing participants by permitting the participants to submit bids;
a logical unit for checking, at or after the expiry of said time period, default final offers prescribed by competing participants; and
a logical unit for registering, if a competing participant's default final offer represents a competitive offer, the offer as a valid bid without any further intervention by that competing participant.

15. The system of claim 14, the online auction involving the award of a supply contract to a supplier selected from a panel of predetermined suppliers which each has a base supply contract with a first party buyer, and the computer network over which the online auction is carried comprising at least one buyer computer, an administrator computer, and at least two supplier computers, said buyer being the first party and said predetermined suppliers being the competing participants, the system including:
a logical unit permitting establishment of key parameters for the supply contract to be submitted by the administrator computer to the at least two supplier computers (eg. price, quality, delivery and service);
a logical unit permitting establishment of a rating for each supplier of the panel of predetermined suppliers related to said key parameters;
a logical unit for receiving during the auction supplier offers from the supplier computers; and
a logical unit for applying the respective ratings to each supplier offer to adjust that offer prior to comparison with any other offer.
